(19) United States
(12) Patent Application Publication
(10) Pub. No.: US 2012/0046900 A1
(43) Pub. Date: Feb. 23, 2012

(54) INSTABILITY MONITORING DEVICE AND SYSTEM, IN PARTICULAR FOR A RAIL VEHICLE

(75) Inventor: Mike Baert, Brugge (BE)

(73) Assignee: BOMBARDIER TRANSPORTATION GmbH, Berlin (DE)

(21) Appl. No.: 13/119,392

(22) PCT Filed: Sep. 18, 2009
(86) PCT No.: PCT/EP2009/006758

§ 371 Date: Nov. 4, 2011

(30) Foreign Application Priority Data
Sep. 19, 2008 (EP) 08290886.4

(51) Int. Cl. G06F 15/00

(52) U.S. Cl. 702/141

(57) ABSTRACT

An instability monitoring device for a rail vehicle, includes: at least a first accelerometer for delivering a first acceleration signal in response to vibration along a reference axis, at least a first solid-state safety relay, having two main terminals and being switchable between a closed state and an open state, and a programmable logic device connected to the first accelerometer and to the first solid-state relay, the programmable logic device is a field programmable gate array (FPGA) or a complex programmable logic device (CPLD), provided with non-volatile logic blocks running simultaneously in parallel and implementing an instability monitoring algorithm to change the state of the first solid-state relay based on an instability condition of the first acceleration signal.

### CROSS-REFERENCE TO RELATED APPLICATIONS

This application is a National Phase Entry of International Application No. PCT/EP2009/006758, filed on Sep. 18, 2009, which claims priority to European Patent Application Serial No. 08290886.4, filed on Sep. 19, 2008, both of which are incorporated by reference herein.

### TECHNICAL FIELD OF THE INVENTION

The invention relates to a system for monitoring the stability of a rail vehicle. More generally, it relates to a safety system for monitoring the stability of distributed components and to distributed devices in such a system.

### BACKGROUND

Conventional bogies are provided with passive stabilisation means like yaw dampers or friction plates, which counteract the tendency of the bogies to follow a sinusoidal path. These stabilisation means are also used to increase the speed—called “instability limit”—at which the rather smooth sinusoidal run deteriorates into bogie hunting, causing bad ride comfort, high forces between wheels and rails and eventually a risk of derailment. To minimize the risk of hazardous run e.g. caused by defective yaw dampers, the TSI HS (Technical Specification of Interoperability—High-Speed) released by the European Commission contains the requirement to install a means on board of high-speed trains, which can detect instability in the bogie movement of a train.

An algorithm for detecting the running instability of bogies of rail passenger vehicles is defined in UIC leaflet 515.5. According to this algorithm, instability is detected whenever the lateral acceleration of the bogie frame above a predetermined threshold in the range of 4 Hz to 8 Hz presents more than a predetermined number (e.g. 6) of consecutive peaks above a predetermined threshold (e.g. 8 m/s²) with a predetermined period of time (e.g. 500 ms).

An instability monitoring system for a bogie is known from EP 1 197 739. The bogie is provided with two longitudinal accelerometers located on each side of a longitudinal centre plane of the bogie. Signals from the two accelerometers are compared and processed to determine if they differ by more than a predetermined amount, in which case an alarm signal is triggered.

A vibration monitoring system for a rail vehicle is known from the documents DE 100 20 519, DE 100 20 520 and DE 100 20 521. One or more accelerometers, preferably tri-axial accelerometers, are connected to a central signal processing unit located at a remote location on the train consist. While this type of configuration may prove adapted to the monitoring of specific vehicle subsystems like brakes, bogies or car bodies for diagnostic purposes, it does not provide the level of safety and reliability required for safety components. In particular, the transmission of the acceleration signals from the accelerometers to the remote processing unit may suffer from an insufficient signal to noise ratio.

FR 2 067 801 discloses an instability monitoring device including an accelerometer for monitoring the stability of the bogie of a locomotive, connected to a relay via a wired analog logic circuit, to change the state of the relay based on an instability condition of the acceleration signal and turn on or off a warning light. A method for indicating the dynamic instability of railway or tramway rolling stock is described in EP 0 195 921. The method essentially consists in detecting, by means of at least one accelerometer sensor, the acceleration of the wheel arrangement of the rolling stock in a direction transverse the direction of travel, suitably processing it and subsequently comparing, in a suitable comparator, the processed acceleration value with a reference value. The indication of instability is obtained by checking whether the number of processed acceleration values which exceed the said reference value is greater than a predetermined number in a predetermined period of time.

An apparatus for recording changes associated with the acceleration of a structure is disclosed in U.S. Patent Publication No. 2004/0102918. The apparatus includes an accelerometer array having at least one silicon beam type accelerometer, a nonvolatile memory, a clock timer, a programmable control unit operatively coupled to the accelerometer array, a non-volatile memory, and clock timer. The accelerometer array, the non-volatile memory, the clock timer and the programmable control unit can be formed on a common semiconductor substrate (e.g., integrated), with the accelerometer array disposed in a central region.

The existing attempts to implement an instability detection device are based on sensors (e.g. accelerometers) and a remote software-based processing unit, which lacks the ability to fulfil the safety and reliability requirements of CENELEC Standards EN 50126-50129 and hence cannot be certified as being safe. While the risk of instability is reduced by the installation of such devices, it cannot be brought down to 0, since an undetected malfunction of the monitoring device during unstable run is still possible.

### SUMMARY

The foregoing shortcomings of the prior art are addressed by the present invention. According to one aspect of the invention, there is provided an instability monitoring device for a rail vehicle, comprising:

at least a first accelerometer for delivering a first acceleration signal in response to vibration along a reference axis,

at least a first solid-state safety relay, having two main terminals and being switchable between a closed state and an open state, and

a programmable logic device connected to the first accelerometer and to the first solid-state relay, the programmable logic device being a field-programmable gate array (FPGA) or a complex programmable logic device (CPLD) provided with non-volatile logic blocks running simultaneously in parallel and implementing an instability monitoring algorithm to change the state of the first solid-state relay based on an instability condition of the first acceleration signal.

The safety loop is based on the switching of the solid-state relay, which makes it possible to mount the circuit on the hard environment of the bogie, where the implementation of electro-mechanical relays would not be possible. Thanks to the use of an hardware base, and in particular to the implementation of a programmable logic device (PLD) for running the instability detection algorithm, the instability monitoring device meets the requirements of the CENELEC standard and can be assigned a Safety Integrity Level (SIL). Obviously, the application is not limited to the railway industry and similar advantages are experienced in other systems or applications combining severe external conditions and high safety requirements. The programmable logic device can be provided with a non-volatile erasable and reprogrammable memory such as a flash memory. Hence, there is no need for a configuration device to put the code into the PLD cells. The PLD is immediately operational after start-up.

According to a preferred embodiment, the instability monitoring algorithm includes:

pre-processing the first acceleration signal

detecting peaks of the pre-processed acceleration signal which are higher than a predetermined acceleration threshold,

incrementing a counter if the time between two consecutive peaks is within a predetermined time window,

activating the solid-state safety relay if the counter reaches or exceeds a predetermined counter threshold, and

resetting the counter if no peak has been detected within a predetermined period of time.

This algorithm is based on the requirements defined in UIC leaflet 515.5. The time window has a lower limit (e.g. 150 ms) and an upper limit (e.g. 250 ms), which provide the equivalent in time of the limited bandwidth in the frequency spectrum considered in the standard. Advantageously, the pre-processing of the first acceleration signal includes processing the first acceleration signal through a low-pass filter and a high-pass filter. The low-pass filter is used to eliminate high frequency noise, while the high-pass filter is used to eliminate DC offset, which may be due to an inadequate positioning of the instability monitoring device.

According to a preferred embodiment, the instability monitoring device further comprises a second accelerometer for delivering a second acceleration signal in response to vibration along the reference axis, the second accelerometer being connected to the programmable logic device, the instability monitoring algorithm changing the state of the first solid-state relay based on an instability condition of the first and second acceleration signals. The use of two accelerometers adds redundancy to the system. Advantageously, each of the first and second accelerometers comprises: an inertia mass movable between a rest position and two opposite limits parallel to the reference axis and an internal test circuit for moving the inertia mass from a rest position towards one of the two opposite limits in one testable direction. The testable directions of the first and second accelerometers are opposite to one another, the acceleration signals generated by the first and second accelerometer in response to movements of each inertia mass between the rest position and the other of the two limits in the direction opposite to the testable direction being disregarded by the programmable logic device. Accelerometers of this type are well-known in the art. The internal circuit may include a capacitive plate cooperating with the inertia mass and connected to a test terminal, such that application of a DC voltage to the test terminal results in a motion of the inertia mass in the testable direction, which simulates a constant acceleration in that direction. The signal generated by the accelerator can be used to test the instability monitoring algorithm in the testable direction. When two such, preferably identical, accelerometers are placed on the same printed circuit board opposite to one another, it becomes possible to implement an instability monitoring algorithm which takes into account only the part of the acceleration signals that can actually be tested.

Advantageously, the first solid-state relay is open in the absence of a control signal and the programmable logic device interrupts the control signal to change the state of the first solid-state relay based on an instability condition of the first acceleration signal. Hence, any loss of power in the instability monitoring device will result in a change of state of the safety relay, which will give a clear indication of the failure of the system.

According to a preferred embodiment, the device further comprises a second solid-state relay connected to the programmable logic device, the algorithm being such as to change the state of the second solid-state relay based on the instability condition of the first acceleration signal. The use of two safety relays adds redundancy to the system. Advantageously, the change of state of the first solid-state relay is triggered by the interruption an AC control signal controlled by the programmable logic device while the change of state of the second solid-state relay is triggered by the interruption of a DC control signal controlled by the programmable logic device. Hence, a scenario in which the programmable logic device is blown up and delivers a constant high DC control voltage will be detected on the first solid-state relay, because of the interruption of the AC control signal. According to a preferred embodiment, there is also provided a printed circuit board for receiving the programmable logic device, the first solid-state safety relay and the first accelerometer and, if provided, the second solid-state safety relay and the second accelerometer.

Advantageously, the device may also be provided with a test circuit comprising:

a test power supply,

a test current detector,

test switch means for switching the instability monitoring device between a test mode and an operational mode, such that in the test mode the main terminals of the safety switch are connected between the local test power supply and the local measuring device while in the operational state the main terminals of the safety switch are disconnected from the local test power supply. The test circuit is used to carry out integrity tests on the safety solid-state relay. If the device includes two safety solid-state relays, two test circuit can be provided, which can share one test power supply and, according to one variant, one current detector.

According to another aspect of the invention, there is provided an instability monitoring system for a rail vehicle comprising:

a plurality of distributed instability monitoring devices as described hereinbefore,

a safety loop interconnecting the first solid-state safety relays of the plurality of instability monitoring devices in series.

Preferably, the safety loop is provided with:

a power supply for feeding the safety loop,

a fault detector for detecting a change of state of at least one of the first state safety relays of the plurality of instability monitoring devices.

The fault detector can be a current detector. The opening of any of the safety solid-state relays due to an instability detected by one of the distributed instability monitoring devices will be immediately detected by the fault detector. The malfunction of any of the distributed instability monitoring devices will also result in the opening of at least one of the safety solid-state relays and will also be detected by the fault detector. According to a further aspect of the invention there is provided a rail vehicle provided with a plurality of bogies and with an instability monitoring system according as described hereinbefore, wherein each bogie is provided with at least one of the instability monitoring devices of the instability monitoring system.

### BRIEF DESCRIPTION OF THE DRAWINGS

Other advantages and features of the invention will become more clearly apparent from the following description of specific embodiments of the invention given as non-restrictive example only and represented in the accompanying drawings in which:

FIG. 1 is a block diagram of an instability monitoring device according to the invention;

FIG. 2 illustrates a couple of a self-testable micro-electromechanical accelerometers of in the instability monitoring device of FIG. 1;

FIGS. 3A to 3K illustrate the processing of acceleration signal by the instability monitoring device of FIG. 1;

FIG. 4A illustrates test circuits used for testing safety solid-state relays of the instability monitoring device of FIG. 1;

FIG. 4B illustrates a variant of FIG. 4A;

FIG. 5A illustrates an instability monitoring system including a plurality of instability monitoring devices of the type illustrated in FIG. 1; and

FIG. 5B illustrates a variant of FIG. 5A.

### DETAILED DESCRIPTION OF VARIOUS EMBODIMENTS

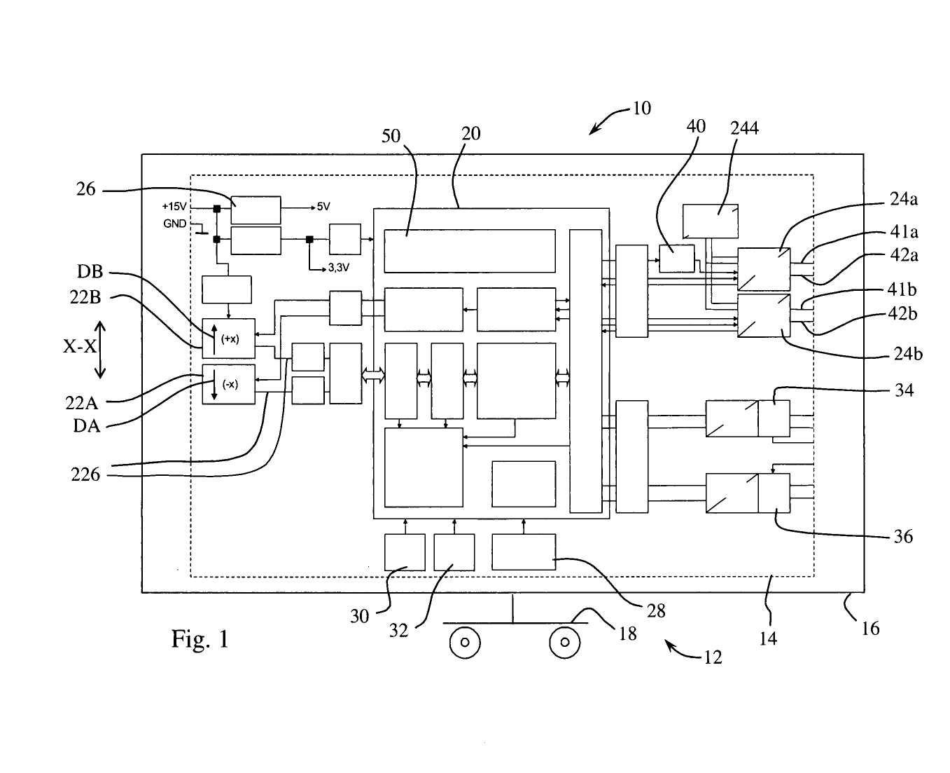

Referring to FIG. 1, an instability monitoring device 10 dedicated to the monitoring of the instability of a bogie 12 includes a printed circuit board 14 mounted in a box 16 fixed to a bogie frame 18. The circuit board 14 is built around a programmable logic device (PLD) 20 having two identical lateral accelerometers 22A, 22B as main inputs and two solid-state safety relays 24a, 24b as main outputs. The system is also equipped, besides the necessary power supply circuits 26, with a temperature sensor 28, a clock circuit 30, a watchdog circuit 32, an input for test demands 34 and outputs for indication of instability 36.

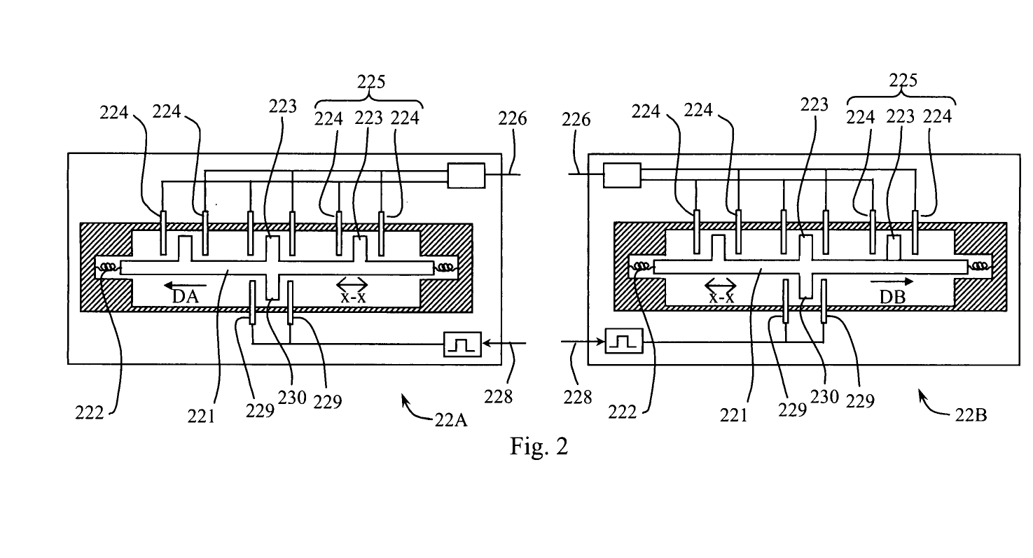

The two lateral acceleration sensors 22A, 22B, depicted in FIG. 2, are preferably of the MEMS (Micro-Electro-Mechanical System) type. This type of accelerometer is well-known in the art (e.g. reference SCA 1000 of VTI Technologies). The accelerometers 22A, 22B include an inertia mass in the form of a polysilicon beam 221 suspended over a substrate by supporting tethers 222. The beam 221, which is essentially parallel to the substrate, is elongated along a reference axis X-X, and provided with a number of plates 223 that extend away from the beam in a direction perpendicular to the axis of the beam. The beam and plates 223 are movable laterally relative to the substrate along the axis X-X. Each of these movable plates 223 is positioned between two polysilicon plates 224 that are perpendicular to the beam 221 and are fixed relative to the substrate. Each movable plate 223 and the fixed plates 224 on either side of the movable plate form a differential capacitor cell 225. The cells additively form a differential capacitor. Instead of polysilicon, the accelerometer may be made of other materials known in the art, such as monocrystalline silicon.

Different approaches can be used to sense acceleration with such a differential capacitor. The movable plates (i.e., movable with the mass) are each centred between two fixed plates in a rest position. All the fixed plates on one side of the movable plates are electrically coupled together and charged, and all the fixed plates on the other side of the movable plates are also electrically coupled together and charged. In response to an external force/acceleration along the reference axis, the mass with movable plates moves toward one or the other set of fixed plates, thus changing the capacitance between the different plates, which produces an electrical signal. This signal on the fixed plates is amplified, processed and provided to an output terminal 226.

To verify proper operation of the sensors 22A, 22B, a self-test input terminal 228 is provided. Activating self-test causes a step function force to be applied to the accelerometer 22 in a testable direction DA, DB parallel to the reference axis X-X. More specifically, activating the self-test via the self-test input terminal 228 causes the voltage on at least a pair of the fixed plates 229 on one side of the moving beam 221 in a test cell 231 to change. This creates an attractive electrostatic force on a test plate 230 integral with the movable beam 221, causing the beam 221 to move from the rest position toward in a testable direction. This sensor displacement in the testable direction changes the signal seen at the sensor output terminal 226.

Remarkably, the two identical accelerometers 22A, 22B are oriented in opposite directions on the printed circuit board, which means that their output have identical absolute instantaneous values and opposite signs when the printed circuit board is subjected to vibration. This also means that their reference axes X-X are aligned and that their testable directions DA, DB are opposite to one another.

The accelerometers 22A, 22B are connected to the programmable logic device PLD via an analog to digital converter A/DC. The programmable logic device can be a field-programmable gate array (FPGA) or a complex programmable logic device (CPLD). It is provided with non-volatile logic blocks running simultaneously in parallel and implementing an instability monitoring algorithm to change the state of the first and second solid-state relays from an active state to a fault state whenever an instability condition is detected.

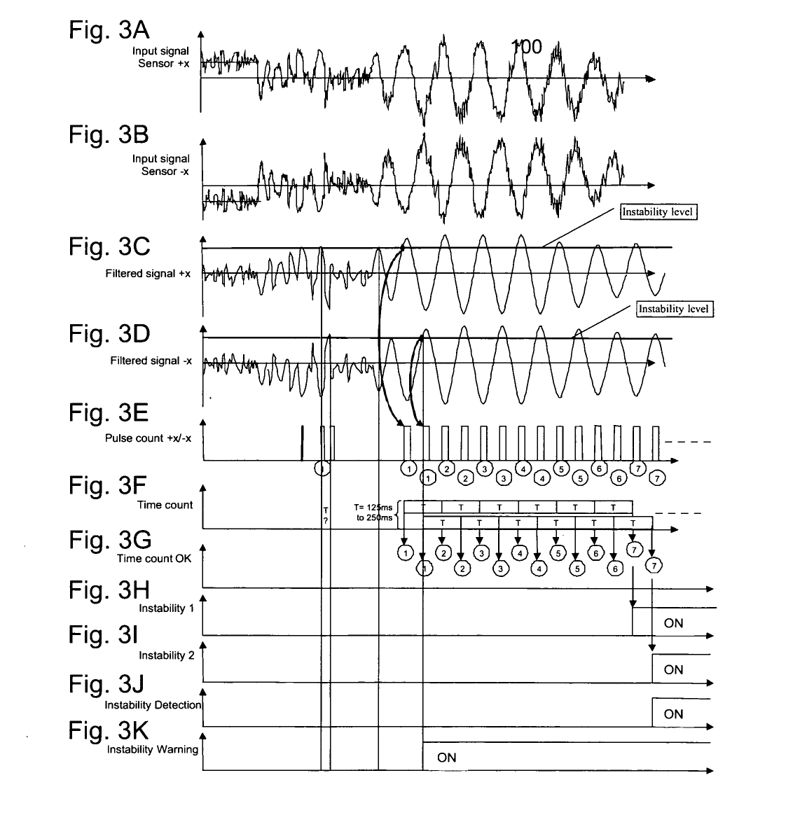

The digitalised acceleration signals from the first and second accelerometers, illustrated in FIGS. 3A and 3B, respectively, are processed in parallel channels as depicted in FIGS. 3C to 3K. When entering the programmable logic device, the digitalised acceleration signal of each accelerometer is first filtered using numerical band-pass filters. The band-pass filter consists of a low-pass and a high-pass second order Butterworth filters. The high-pass filter is used to eliminate signal offset. Its cutoff frequency (the −3 dB frequency) is 3 Hz. The low-pass filter has a cutoff frequency between 30 and 40 Hz to eliminate noise. The resulting filtered signals are shown in FIGS. 3C and 3D. Peaks of the filtered signals above a predetermined threshold are detected as illustrated in FIG. 3E. The threshold is set for each accelerometer 22A, 22B in the direction corresponding to the corresponding testable direction DA, DB (i.e. a positive threshold in this example). Peaks of each acceleration signal in the direction opposite to the testable direction are not taken into account. Starting from zero, a counter is incremented for each accelerometer when consecutive peaks are detected within a predetermined time window, e.g. when two consecutive peaks are distant from one another by more than 125 ms and less than 250 ms, as illustrated in FIG. 3F. More precisely, a timer is started after each incrementation of the counter. If the time between the last counted peak and the new peak (measured by the timer) is less than 120 ms or more than 250 ms but less than 500 ms, the counter is not updated. The counter and the timer are reset to 0 if no peak has been detected during a period T=500 ms after the last peak or if peaks less than 125 ms or more than 250 ms apart are detected after the period of 500 ms. An instability signal is delivered whenever the counter reaches N for one accelerometer as illustrated in FIGS. 3H and 3I, in which case the timer and counter are also reset. An instability detection signal is delivered when an instability signal is detected for both accelerometers, as illustrated in FIG. 3J. A warning signal can also be delivered at an earlier stage, e.g. as soon as the first or second peak is detected on both channels, as illustrated in FIG. 3K. Remarkably, the algorithm used for detecting instabilities uses only one part of each acceleration signal, namely the part that corresponds to the testable direction of each accelerometer.

Each safety solid-state relay 24a, 24b is provided with two output terminals 41a, 42a, 41b, 42b and is designed to change its state from an active state to a fault state upon change of the corresponding control signal on a control input terminal. The first and second solid-state relays 24a, 24b act as “normally open” contacts, which means that they are closed when energised and open in the absence of control signal. More specifically, an AC control signal of predetermined frequency (e.g. 1000 Hz) is supplied by the programmable logic device 20 to a frequency detector 40 connected to the first solid-state relay 24a in the absence of instability to maintain the first solid-state relay in its active, closed state. In the same circumstances, a DC control signal is supplied by the programmable logic device 20 to the second solid-state relay 24b to maintain it in the closed state. The detection of instability triggers the interruption of the two control signals and the opening of the two safety solid-state relays 24a, 24b.

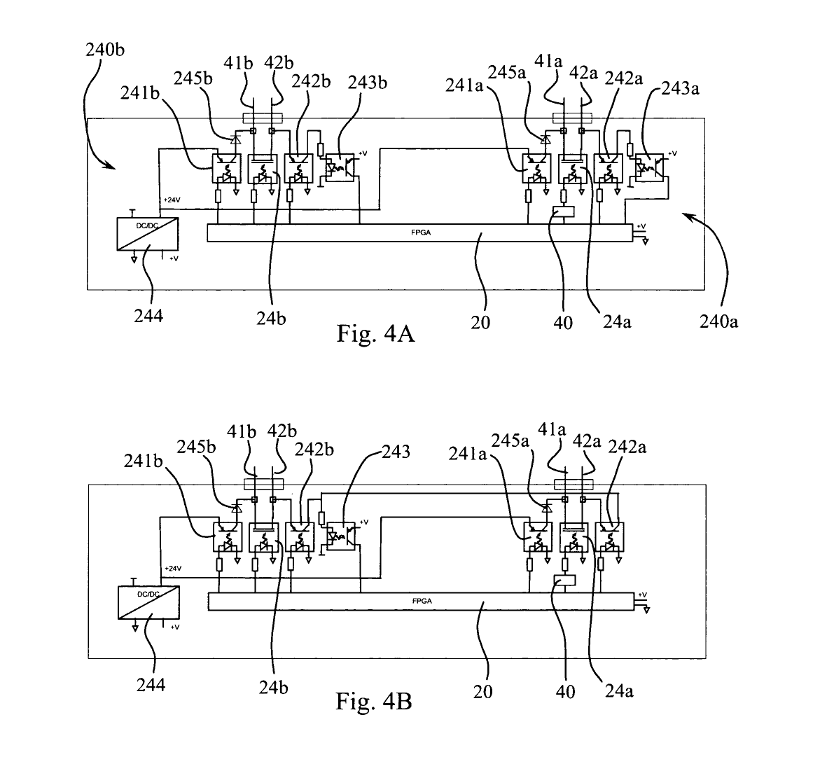

Referring to FIG. 4A, the solid-state relay 24a is provided with a local test circuit 240a including two test switches 241a, 242a and a test current detector 243a. An upstream branch of the local test circuit 240a connects one of the test switches 241a in series between one terminal 41a of the solid-state relay and the positive terminal a local test DC power supply 244. A diode 245a can be provided in the upstream branch to prevent current backflow into the local test power supply. The downstream branch of the local test circuit connects the other output terminal 42a of the solid-state relay to the second test switch 242a and the latter to the test current detector 243a which is connected to the ground defined by the negative terminal of the local test power supply 244 to close the circuit. The current detector 243a is used to detect the presence of current through the terminals 41a, 42a of the solid-state relay when the first and second test switches 241a, 242a are closed as well as the solid-state relay. The second solid-state relay 24b is provided with a similar test circuit using the same power supply 244, and the corresponding parts have been designated in FIG. 4A with the same reference numbers, using a “b” as suffix instead of “a”. As shown in the variant of FIG. 4B, a common current detector 243 can be used instead of two separate current detectors 243a and 243b.

The solid-state relays 24a, 24b, the pairs of test switches 241, 242 and the current detector 243 are connected to the programmable logic device 20 and are realised as optocouplers so that their connections to the programmable logic device 20 are fully isolated from their connections to the test circuit. The programmable logic device 20 is also provided with a finite state machine 50 (see FIG. 1) for performing a series of tests for checking the operability of the instability monitoring device.

In a first test sequence, the switching of the solid-state relays is checked. The programmable logic device 20 closes the test switches 241, 242 of the first solid-state relay 24a and interrupts the AC control signal for a predetermined duration while the response of the first solid-state relay 24a is checked by the test current detector 243. If a current is detected by the test current detector 243 during the interruption of the AC control signal the test has failed and the state machine goes to the start-up fault state. Subsequently, the test is repeated for the second solid-state relay 24b, with the appropriate DC control signal being interrupted and switched back ON by the programmable logic device.

In a second test sequence, the internal test circuits of the accelerometers are used to simulate a test pattern that corresponds to an instability situation. A series of N voltage pulses is applied to the test terminals of the two accelerometers. The two accelerometers should then react with 80% of their full scale value and generate N peaks above the detection threshold. After N peaks, the instability monitoring algorithm should generate an instability signal and trigger the two solid-state switches. If no instability signal is generated, the test has failed and the state machine 50 goes to the start-up fault state.

Remarkably, the use of two accelerometers 22A, 22B oriented in opposite directions in each instability monitoring device makes it possible to selectively detect in the actual monitoring algorithm the peaks of each accelerometer signal that corresponds to movements of the inertia mass from the rest position in the testable direction, which has actually been tested. In other words, the peak threshold of the algorithm is set so that the peaks of the accelerometer signal in the direction opposite to the testable direction, i.e. the direction for which the internal test circuit of the accelerometer do not allow testing, are disregarded.

The instability monitoring devices may include other tests, e.g. temperature measurements. The temperature measured by a temperature sensor is compared with lower and upper limits (e.g. between −40 and 95° C.). If the temperature is not within the predefined window, an alarm is triggered.

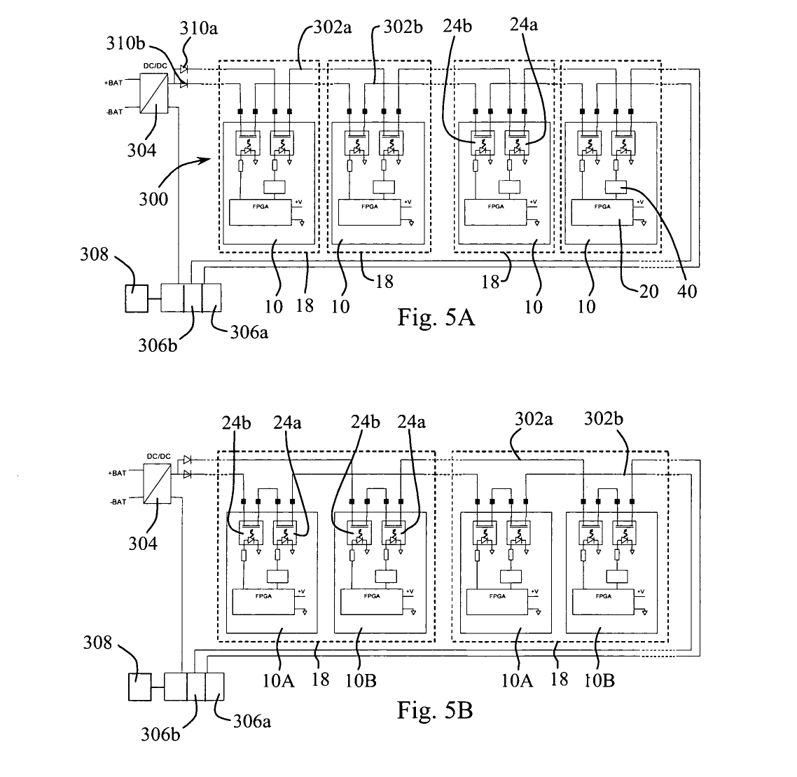

As illustrated in FIG. 5A, the instability monitoring device is duplicated on at least some of the bogie frames 18 of the rail vehicle, and preferably on all bogies, to build an instability monitoring system 300, which includes two safety loops 302a, 302b, one for connecting the first safety relays 24a of the instability monitoring devices 10 in series in a closed circuit including a DC power supply, e.g. a battery unit 304 and a common current detector 306a connected to an alarm 308 in the driver's cab, to a speed control system and/or to a brake control system of the vehicle, and the second one (302b) for connecting in the same conditions the second safety relays 24b of the instability monitoring devices 10 in series between the power supply 304 and a current detector 306b. Diodes 310a, 310b are also provided on the safety loops to prevent current backflow into the DC power supply 304.

Any interruption of the current detected a current detector 306a, 306b in the safety loop is considered as an instability event and results in appropriate action, e.g. operation of the alarm 308, decrease of the driving power and/or operation of the brakes of the rail vehicle. The ground of each local test DC power supply 244 is isolated, so that the first test sequence referred to above can be carried out simultaneously on all first safety relays 24a, with superposition of the DC power of the safety loop 302a. However, the first and second safety relays of each unit should preferably be tested sequentially to avoid unreliable results, since it is envisaged that both safety loops are connected in series.

The instability monitoring system is provided with a test bus for performing controlling the start-up tests various tests on the distributed system to check its operability. The test bus is used to send test request to the instability monitoring device and gather the results.

To test the integrity of the safety loop cabling in a configured train, a special vehicle test can be executed. The instability monitoring devices of the last car shall be shutdown and powered again by means of the circuit-breaker of the rail car. This action will open and close the safety loop at this location and this will be verified in the driver's cab. If this test is positive it is considered that the whole safety loop is working. If not, the action shall be repeated on the instability monitoring device which is located directly upstream and this until the error is found. In such a case, the error in the cabling will be situated between the unit for which the loop is functioning and the next unit downstream. As a variant, the two safety loops can be connected in series between a common power supply and a common current detector.

To limit availability problems in case of failure of one of the instability monitoring devices, it is also envisaged to provide each bogie with a first instability monitoring device 10A and a second instability monitoring device 10B, as illustrated in FIG. 5B. The safety relays 24a and 24b of each instability monitoring device are connected in series. The safety relays 24a, 24b of the first instability monitoring devices 10A are connected to a first safety loop 302A and the safety relays 24a, 24b of the second instability monitoring devices are connected to a second safety loop 302B. When one instability monitoring device is in failure and interrupts one of the safety loops, operation can be continued on the other safety loop. The invention is not limited to the embodiments described hereinbefore. If redundancy of the acceleration measurements is not critical, a single accelerometer can be used. Preferably, the single accelerometer should have two testable directions, i.e. it should be provided with test means for moving the inertia mass of the accelerometer on both sides of its rest position. The accelerometer or accelerometers can be biaxial or triaxial, in which case the signal from the additional axes can be simply disregarded or processed in parallel with the signal from the first axis. The signals from different axes can also be combined to build an acceleration vector, which will be processed by the programmable logic device. The accelerometers can be of any convenient type, e.g. based on piezoelectric transducers.

The instability monitoring algorithm can have many variants. In particular, the use of a time window with a lower and an upper threshold for counting the peaks can be replaced by more sophisticated numerical filters for disregarding the parts of the signal that are not in the observed frequency range. If redundancy of the safety solid-state relays is not critical, one option is to eliminate one of the two solid-state relays, in which case the instability monitoring system will be provided with one safety loop only. The instability monitoring system, which has been used in connection with a rail vehicle, can also implemented in various complex systems in which distributed acceleration measurements are necessary to determine an instability condition, e.g. aircrafts or turbines of a power plant.

1. An instability monitoring device for a rail vehicle, comprising:
at least a first accelerometer for delivering a first acceleration signal in response to vibration along a reference axis;
at least a first solid-state safety relay, having two main terminals and being switchable between a closed state and an open state; and
a programmable logic device connected to the first accelerometer and to the first solid-state relay, the programmable logic device being a field programmable gate array (FPGA) or a complex programmable logic device (CPLD) provided with non-volatile logic blocks running simultaneously in parallel and implementing an instability monitoring algorithm to change the state of the first solid-state relay based on an instability condition of the first acceleration signal.

2. The instability monitoring device of claim 1, wherein the programmable logic device includes a non-volatile erasable and reprogrammable memory.

3. The instability monitoring device of claim 1, wherein the instability monitoring algorithm includes:
pre-processing the first acceleration signal;
detecting peaks of the pre-processed acceleration signal which are higher than a predetermined acceleration threshold;
incrementing a counter if the time between two consecutive peaks is within a predetermined time window;
activating the solid-state safety relay if the counter reaches or exceeds a predetermined counter threshold; and
resetting the counter if no peak has been detected within a predetermined period of time.

4. The instability monitoring device of claim 1, wherein the pre-processing of the first acceleration signal includes processing the first acceleration signal through a low-pass filter and a high-pass filter.

5. The instability monitoring device of claim 1, further comprising a second accelerometer for delivering a second acceleration signal in response to vibration along the reference axis, the second accelerometer being connected to the programmable logic device, the instability monitoring algorithm changing the state of the first solid-state relay based on an instability condition of the first and second acceleration signals.

6. The instability monitoring device of claim 1, wherein each of the first and second accelerometers comprises:
an inertia mass movable between a rest position and two opposite limits parallel to the reference axis; and
an internal test circuit for moving the inertia mass from a rest position towards one of the two opposite limits in one testable direction;
wherein the testable directions of the first and second accelerometers are opposite to one another, the acceleration signals generated by the first and second accelerometer in response to movements of each inertia mass between the rest position and the other of the two limits in the direction opposite to the testable direction being disregarded by the programmable logic device.

7. The instability monitoring device of claim 1, wherein the first solid-state relay is open in the absence of a control signal and the programmable logic device interrupts the control signal to change the state of the first solid-state relay based on an instability condition of the first acceleration signal.

8. The instability monitoring device of claim 1, further comprising a second solid-state relay connected to the programmable logic device, the algorithm being such as to change the state of the second solid-state relay based on the instability condition of the first acceleration signal.

9. The instability monitoring device of claim 8, wherein the change of state of the first solid-state relay is triggered by the interruption an AC control signal controlled by the programmable logic device while the change of state of the second solid-state relay is triggered by the interruption of a DC control signal controlled by the programmable logic device.

10. The instability monitoring device of claim 1, further comprising a printed circuit board for receiving the programmable logic device, the first solid-state safety relay and the first accelerometer and, if provided, the second solid-state safety relay and the second accelerometer.

11. The instability monitoring device of claim 1, further provided with a test circuit comprising:
a test power supply;
a test current detector; and
a test switch operably switching the instability monitoring device between a test mode and an operational mode, such that in the test mode the main terminals of the safety switch are connected between the local test power supply and the local measuring device while in the operational state the main terminals of the safety switch are disconnected from the local test power supply.

12. An instability monitoring system for a rail vehicle, comprising:
(a) a plurality of rail vehicle-distributed instability monitoring devices comprising:
at least a first accelerometer for delivering a first acceleration signal in response to vibration of the rail vehicle along a reference axis;
at least a first solid-state safety relay, having two main terminals and being switchable between a closed state and an open state;
a programmable logic device connected to the first accelerometer and to the first solid-state relay, the programmable logic device being a field programmable gate array (FPGA) or a complex programmable logic device (CPLD) provided with non-volatile logic blocks running simultaneously in parallel and implementing an instability monitoring algorithm to change the state of the first solid-state relay based on an instability condition of the first acceleration signal; and
(b) a safety loop interconnecting the first solid-state safety relays of the plurality of instability monitoring devices in series.

13. The instability monitoring system of claim 12, wherein the safety loop is provided with:
a power supply for feeding the safety loop; and
a fault detector for detecting a change of state of at least one of the first state safety relays of the plurality of instability monitoring devices.

14. A rail vehicle comprising provided a plurality of bogies and with an instability monitoring system, wherein each bogie is provided with at least one instability monitoring device of the instability monitoring system, the at least one instability monitoring device further comprising:
at least a first accelerometer for delivering a first acceleration signal in response to vibration along a reference axis;
at least a first solid-state safety relay, having two main terminals and being switchable between a closed state and an open state;
a programmable logic device connected to the first accelerometer and to the first solid-state relay, the programmable logic device being a field programmable gate array (FPGA) or a complex programmable logic device (CPLD) provided with non-volatile logic blocks running simultaneously in parallel and implementing an instability monitoring algorithm to change the state of the first solid-state relay based on an instability condition of the first acceleration signal; and
a safety loop interconnecting the first solid-state safety relays of the plurality of instability monitoring devices in series.
